(19) United States
(12) Patent Application Publication
(10) Pub. No.: US 2021/0379847 A1
(43) Pub. Date: Dec. 9, 2021

(54) NON-PNEUMATIC TIRE FABRICATED IN ONE-STEP MOLDING

(71) Applicant: Camso Inc., Magog (CA)

(72) Inventor: Ronald Hobart THOMPSON, Marietta, SC (US)

(21) Appl. No.: 17/288,367

(22) PCT Filed: Oct. 25, 2019
(86) PCT No.: PCT/CA19/51514

§ 371 Date: Apr. 23, 2021

Related U.S. Application Data
(60) Provisional application No. 62/750,305, filed on Oct. 25, 2018.

(51) Int. Cl. B29D 30/02; B60C 7/24; B60C 7/14; B29C 33/12; B29C 41/04; B29C 39/08

(52) U.S. Cl. CPC B29D 30/02; B60C 7/24; B60C 7/143; B60C 2007/005; B29C 41/042; B29C 39/08; B29C 33/12

(57) ABSTRACT

A wheel for a vehicle is non-pneumatic (i.e., airless), may be designed to enhance its use and performance and/or use and performance of the vehicle, and may be manufactured efficiently, including by a single non-pneumatic tire molding operation that can allow rigid rim incorporation and complex tread implementation.

### CROSS-REFERENCE TO RELATED APPLICATION

This application claims priority from U.S. Provisional Patent Application 62/750,305 filed on Oct. 25, 2018 and incorporated by reference herein.

### FIELD

This disclosure relates to non-pneumatic tires (NPTs) for various vehicles and applications. Specifically, the disclosure relates to manufacturing methods, materials, and mold and tire geometries that permit ease of manufacturing.

### BACKGROUND

NPTs have advantages over pneumatic tires, particularly in areas of maintenance, durability, and reliability. However, market success of NPTs has been limited due to performance issues and high price. NPTs may have poor performance in ride quality, particularly if the NPT is “solid” or otherwise transmits load from the ground to the rim via compressive forces. Also, due to high mass and/or complex manufacturing methods, the production costs may be higher than a comparable pneumatic tire.

Recent patent disclosures show progress in these areas. U.S. Pat. No. 9,751,270, owned by the current applicant, discloses NPT geometries and manufacturing methods that may be cost effective, yet provide compliance and ride comfort like a pneumatic tire. U.S. patent application Ser. No. 15/549,024, also owned by the current applicant, also discloses manufacturing methods that may be cost effective. Both of these patent documents are hereby fully incorporated by reference.

Yet, in both above disclosures, there are potential disadvantages:
The preferred embodiments have elastomeric rims. See paragraph 0078 of application Ser. No. 15/549,024 and line 53, Column 4 of U.S. Pat. No. 9,751,270. While allowing for metallic rims, these prior art examples do not disclose productions methods by which such structures may comprise metallic rim. Elastomeric rims may not be as robust, as resistant to heating from brakes and then like, and may not be as suitable for fixation to vehicle hubs as would be a metallic rim.
Incorporating an elastomeric tread of suitable characteristics may require a secondary operation. See FIG. 22 of U.S. Pat. No. 9,751,270, for example. Such secondary operations may add expense and complexity.

Application Ser. No. 15/549,024 references horizontal spin casting (HSC) as a possible manufacturing process. With HSC, a mold cavity is filled with a liquid prepolymer/curative mixture using centrifugal force, as the mold rotates around a horizontal axis parallel to the ground and the mold rotates in a vertical plane. The mold must fill from the outer circumference to the inner circumference. A metal rim traversing the lateral extents of the tire would block the flow of this material. Thus, it would be difficult to envision incorporating a metallic rim in the molding process.

Conversely, U.S. Pat. No. 8,991,455 B2 discloses a mold for a non-pneumatic tire which rotates in the horizontal plane, around a vertical axis. This is known as Vertical Spin Casting (VSC). With such a manufacturing process, a metallic rim may be inserted into the mold. The liquid material may be poured in a vertical direction, near the radially outer perimeter of the rim, and the mold fills from the bottom towards the top. This solves the problem noted above for HSC.

However, HSC has a virtue noted in application Ser. No. 15/549,024. HSC enables elastomeric laminate architectures. With HSC, the centrifugal acceleration due to mold rotation is aligned with the acceleration due to gravity. One prepolymer/curative liquid may be poured first; then a second liquid may be poured second, etc., creating multiple layers distributed in a radial dimension of the tire. Hence, with HSC it is possible to first pour a low modulus tread material, and then a high modulus structural core material. With VSC, this is not possible, as the liquid polymer is exposed to vertical acceleration, due to gravity, and to tire radial acceleration, due to mold rotation. With VSC, a tread must be affixed in a secondary operation. Alternatively, a cured tread may be placed in the VSC mold, pretreated such that the liquid polymer bonds to it. Either way, the tread must be molded and cured in a separate process, resulting in greater complexity and cost.

Yet, even given this virtue of HSC—the promise of in-situ forming a tread—no disclosures have been made in the prior art showing how one might form a complex tread pattern in a rotating mold, then demold the tire. Application Ser. No. 15/549,024 shows a tread pattern in FIG. 19, but this tread pattern can be formed using a simple clamshell mold.

To fully leverage the positive attributes of HSC, problems must be solved. For example, a design that enables a metallic or other rigid rim to be comprised in a tire formed in one molding operation is unavailable. As another example, a mold design which can be used in-situ with HSC such that complex tread features may be formed and demolded is also unavailable.

For at least these and other reasons, there is a need for improvements in NPTs and their manufacturing.

### SUMMARY

According to various aspects of this disclosure, a wheel for a vehicle is non-pneumatic (i.e., airless), may be designed to enhance its use and performance and/or use and performance of the vehicle, and may be manufactured efficiently, including by a single non-pneumatic tire molding operation that can allow rigid rim incorporation and complex tread implementation.

According to various aspects of this disclosure, a rim design is disclosed for HSC that permits non-pneumatic tire molding in one operation.

According to various aspects of this disclosure, a mold design for HSC is provided permitting molding of a complex tread. The tread may comprise tread recesses that are disposed in the lateral direction of the tire, and the tread may comprise recesses that are disposed in the circumferential direction of the tire. These recesses, or grooves, may be combined to form tread blocks that are of any suitable shape for proper tire performance.

According to various aspects of this disclosure, a tension-based NPT is provided which can be formed in one molding operation. The NPT may comprise a rim comprising a high modulus material and may further comprise an elastomeric tread with a complex tread pattern. The high modulus rim material may have a modulus that is at least 50 times that of an elastomeric tire material. In some cases, the high modulus rim material may be metallic.

For example, according to one aspect, this disclosure relates to a non-pneumatic tire comprising: an elastomeric annular body comprising an elastomeric material; and a rigid rim extending radially inwardly from the elastomeric annular body and comprising a rigid material stiffer than the elastomeric material. The elastomeric annular body is molded onto the rigid rim in a mold by rotation of the mold about a horizontal axis of rotation of the mold.

According to another aspect, this disclosure relates to a non-pneumatic tire comprising: an elastomeric annular body; and a metallic rim extending radially inwardly from the elastomeric annular body. The elastomeric annular body is molded onto the metallic rim in a mold by rotation of the mold about a horizontal axis of rotation of the mold.

According to another aspect, this disclosure relates to a non-pneumatic tire comprising an elastomeric annular body. The elastomeric annular body comprises a tread including tread recesses disposed between tread projections in a lateral direction of the non-pneumatic tire. The elastomeric annular body is molded in a mold by rotation of the mold about an axis of rotation of the mold.

According to another aspect, this disclosure relates to a non-pneumatic tire comprising an elastomeric annular body. The elastomeric annular body comprises a tread. The elastomeric annular body is molded in a mold by rotation of the mold about an axis of rotation of the mold. The tread is demoldable only by movement of at least part of the mold in a radial direction of the non-pneumatic tire.

According to another aspect, this disclosure relates to a non-pneumatic tire comprising an elastomeric annular body. The elastomeric annular body comprises: an annular beam configured to deflect at a contact patch of the non-pneumatic tire with a ground surface; and an annular support extending radially inwardly from the annular beam and configured such that, when the non-pneumatic tire is loaded, an upper portion of the annular support above an axis of rotation of the non-pneumatic tire is in tension. The non-pneumatic tire comprises a metallic rim extending radially inwardly from the elastomeric annular body.

According to another aspect, this disclosure relates to a mold for manufacturing a non-pneumatic tire. The non-pneumatic tire comprises an elastomeric annular body. The elastomeric annular body comprises a tread. The mold is rotatable about an axis of rotation to mold the elastomeric annular body. The mold comprises a mold member movable in a radial direction of the non-pneumatic tire to demold the non-pneumatic tire.

These and other aspects of this disclosure will now become apparent to those of ordinary skill in the art upon review of a description of embodiments in conjunction with the accompanying drawings.

### BRIEF DESCRIPTION OF THE DRAWINGS

A detailed description of embodiments is provided below, by way of example only, with reference to the accompanying drawings, in which:

FIG. 1 shows an example of a vehicle, in this case a front end loader used in the construction industry, equipped with non-pneumatic tires in accordance with an embodiment;

FIG. 2 shows an example schematic of horizontal spin casting;

FIG. 3 shows an example schematic of vertical spin casting;

FIG. 4 illustrates an exemplary embodiment of a non-pneumatic tire including a rim and a complex tread;

FIG. 5 shows an exemplary embodiment of the tire of FIG. 3, without the complex tread;

FIG. 6 is an RZ plane view of a rim for use with the non-pneumatic tire;

FIG. 7 is an orthogonal view of the rim;

FIG. 8 is a view of a rim flange area of the tire and rim;

FIG. 9 shows examples of alternatives of the rim in other embodiments;

FIG. 10 is a view of a closed mold used to form the tire;

FIG. 11 is a view of the open mold;

FIG. 12 is a view of one half of the mold, with a plurality of sectors in an open position;

FIG. 13 is a view of the sectors in the open position, with one sector in a closed position;

FIG. 14 shows a view of the tread;

FIG. 15 shows a finite element model (FEM) of the tire and rim; and

FIG. 16 shows a deformed FEM of the tire and rim.

It is to be expressly understood that the description and drawings are only for purposes of illustrating certain embodiments and are an aid for understanding. They are not intended to and should not be limiting.

### DETAILED DESCRIPTION OF EMBODIMENTS

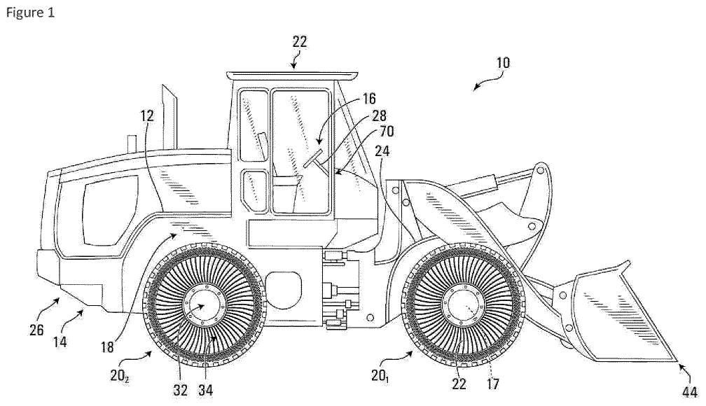

FIG. 1 shows an example of a vehicle 10 comprising wheels 20₁-20₄ in accordance with an embodiment of the invention. In this embodiment, the vehicle 10 is an industrial vehicle. The industrial vehicle 10 is a heavy-duty vehicle designed to travel off-road to perform industrial work using a work implement 44. In this embodiment, the industrial vehicle 10 is a construction vehicle for performing construction work using the work implement 44. More particularly, in this embodiment, the construction vehicle 10 is a loader (e.g., a front-end loader). The construction vehicle 10 may be a bulldozer, a backhoe loader, an excavator, a dump truck, or any other type of construction vehicle in other embodiments. In this example, the construction vehicle 10 comprises a frame 12, a powertrain 14, a steering system 16, a suspension 18, the wheels 20₁-20₄, and an operator cabin 22, which enable a user, i.e., an operator, of the construction vehicle 10 to move the vehicle 10 on the ground and perform work using the work implement 44. The construction vehicle 10 has a longitudinal direction, a widthwise direction, and a height direction.

In this embodiment, as further discussed later, each of the wheels 20₁-20₄ is non-pneumatic (i.e., airless), may be designed to enhance its use and performance and/or use and performance of the construction vehicle 10, and may be manufactured efficiently, including by a single non-pneumatic tire molding operation that can allow rigid rim incorporation and complex tread implementation.

The powertrain 14 is configured for generating motive power and transmitting motive power to respective ones of the wheels 20₁-20₄ to propel the construction vehicle 10 on the ground. To that end, the powertrain 14 comprises a prime mover 26, which is a source of motive power that comprises one or more motors. For example, in this embodiment, the prime mover 26 comprises an internal combustion engine. In other embodiments, the prime mover 26 may comprise another type of motor (e.g., an electric motor) or a combination of different types of motor (e.g., an internal combustion engine and an electric motor). The prime mover 26 is in a driving relationship with one or more of the wheels 20₁-20₄. That is, the powertrain 14 transmits motive power generated by the prime mover 26 to one or more of the wheels 20₁-20₄ (e.g., via a transmission and/or a differential) in order to drive (i.e., impart motion to) these one or more of the wheels 20₁-20₄.

The steering system 16 is configured to enable the operator to steer the construction vehicle 10 on the ground. To that end, the steering system 16 comprises a steering device 28 that is operable by the operator to direct the construction vehicle 10 along a desired course on the ground. The steering device 28 may comprise a steering wheel or any other steering component (e.g., a joystick) that can be operated by the operator to steer the construction vehicle 10. The steering system 16 responds to the operator interacting with the steering device 28 by turning respective ones of the wheels 20₁-20₄ to change their orientation relative to part of the frame 12 of the construction vehicle 10 in order to cause the vehicle 10 to move in a desired direction. In this example, a front frame member 23₁ carrying front ones of the wheels 20₁-20₄ is turnable in response to input of the operator at the steering device 28 to change its orientation and thus the orientation of the front ones of the wheels 20₁-20₄ relative to a rear frame member 23₂ of the construction vehicle 10 in order to steer the vehicle 10 on the ground.

The suspension 18 is connected between the frame 12 and the wheels 20₁-20₄ to allow relative motion between the frame 12 and the wheels 20₁-20₄ as the construction vehicle 10 travels on the ground. For example, the suspension 18 may enhance handling of the construction vehicle 10 on the ground by absorbing shocks and helping to maintain traction between the wheels 20₁-20₄ and the ground. The suspension 18 may comprise an arrangement of springs and dampers. A spring may be a coil spring, a leaf spring, a gas spring (e.g., an air spring), or any other elastic object used to store mechanical energy. A damper (also sometimes referred to as a “shock absorber”) may be a fluidic damper (e.g., a pneumatic damper, a hydraulic damper, etc.), a magnetic damper, or any other object which absorbs or dissipates kinetic energy to decrease oscillations. In some cases, a single device may itself constitute both a spring and a damper (e.g., a hydropneumatic, hydrolastic, or hydragas suspension device).

The operator cabin 22 is where the operator sits and controls the construction vehicle 10. More particularly, the operator cabin 22 comprises a user interface 70 including a set of controls that allow the operator to steer the construction vehicle 10 on the ground and operate the work implement 44. The user interface 70 also comprises an instrument panel (e.g., a dashboard) which provides indicators (e.g., a speedometer indicator, a tachometer indicator, etc.) to convey information to the operator.

The wheels 20₁-20₄ engage the ground to provide traction to the construction vehicle 10. More particularly, in this example, the front ones of the wheels 20₁-20₄ provide front traction to the construction vehicle 10 while the rear ones of the wheels 20₁-20₄ provide rear traction to the construction vehicle 10.

Each wheel 20ᵢ comprises a non-pneumatic tire 34 for contacting the ground and a hub 32 for connecting the wheel 20ᵢ to an axle 17 of the construction vehicle 10. The non-pneumatic tire 34 is a compliant wheel structure that is not supported by gas (e.g., air) pressure and that is resiliently deformable (i.e., changeable in configuration) as the wheel 20ᵢ contacts the ground.

The non-pneumatic tire 34 has an axial direction defined by an axis of rotation 35 of the non-pneumatic tire 34 (also referred to as a lateral, widthwise or “Y” direction), a radial direction (also referred to as a “Z” direction), and a circumferential direction (also referred to as a “X” direction). The non-pneumatic tire 34 has an outer diameter D_{T} and a width W_{T}. It comprises an inboard lateral side 47 for facing a center of the construction vehicle 10 in the widthwise direction of the construction vehicle 10 and an outboard lateral side 49 opposite the inboard lateral side 47. When it is in contact with the ground, the non-pneumatic tire 34 has an area of contact 25 with the ground, which may be referred to as a “contact patch” of the non-pneumatic tire 34 with the ground. The contact patch 25 of non-pneumatic tire 34, which is a contact interface between the non-pneumatic tire 34 and the ground, has a dimension L_{c}, referred to as a “length”, in the circumferential direction of the non-pneumatic tire 34 and a dimension W_{c}, referred to as a “width”, in the axial direction of the non-pneumatic tire 34.

The non-pneumatic tire 34 comprises an elastomeric annular body 19. More particularly, in this embodiment, the elastomeric annular body 19 comprises an annular beam 36 and an annular support 41 that is disposed between the annular beam 36 and the hub 32 of the wheel 20ᵢ and configured to support loading on the non-pneumatic tire 34 as the non-pneumatic tire 34 engages the ground. In this embodiment, the non-pneumatic tire 34 is tension-based such that the annular support 41 is configured to support the loading on the non-pneumatic tire 34 by tension. That is, under the loading on the non-pneumatic tire 34, the annular support 41 is resiliently deformable such that a lower portion 27 of the annular support 41 between the axis of rotation 35 of the non-pneumatic tire 34 and the contact patch 25 of the non-pneumatic tire 34 is compressed or bent (e.g., with little reaction force vertically) and an upper portion 29 of the annular support 41 above the axis of rotation 35 of the non-pneumatic tire 34 is in tension to support the loading.

The annular beam 36 of the non-pneumatic tire 34 is configured to deflect under the loading on the non-pneumatic tire 34 at the contact patch 25 of the non-pneumatic tire 34 with the ground. For instance, the annular beam 36 functions like a beam in transverse deflection. An outer peripheral extent 46 of the annular beam 36 and an inner peripheral extent 48 of the annular beam 36 deflect at the contact patch 25 of the non-pneumatic tire 34 under the loading on the non-pneumatic tire 34. In this embodiment, the annular beam 36 is configured to deflect such that it applies a homogeneous contact pressure along the length L_{c} of the contact patch 25 of the non-pneumatic tire 34 with the ground. The annular beam 36 has a radius R_{BEAM} defined by its outer peripheral extent 36.

More particularly, in this embodiment, the annular beam 36 comprises a shear band 39 configured to deflect predominantly by shearing at the contact patch 25 under the loading on the non-pneumatic tire 34. That is, under the loading on the non-pneumatic tire 34, the shear band 39 deflects significantly more by shearing than by bending at the contact patch 25. The shear band 39 is thus configured such that, at a center of the contact patch 25 of the non-pneumatic tire 34 in the circumferential direction of the non-pneumatic tire 34, a shear deflection of the shear band 39 is significantly greater than a bending deflection of the shear band 39. For example, in some embodiments, at the center of the contact patch 25 of the non-pneumatic tire 34 in the circumferential direction of the non-pneumatic tire 34, a ratio of the shear deflection of the shear band 39 over the bending deflection of the shear band 39 may be at least 1.2, in some cases at least 1.5, in some cases at least 2, in some cases at least 3, and in some cases even more (e.g., 4 or more). For instance, in some embodiments, the annular beam 36 may be designed based on principles discussed in U.S. Pat. No. 9,751,270, which is hereby incorporated by reference herein, in order to achieve the homogeneous contact pressure along the length L_{c} of the contact patch 25 of the non-pneumatic tire 34 with the ground.

In this example of implementation, the shear band 39 comprises an outer band 31, an inner band 33, and a plurality of voids 56₁-56_{N} between the outer band 31 and the inner band 33. The shear band 39 also comprises a plurality of interconnecting members 37₁-37_{P} that extend between the outer band 31 and the inner band 33 and are disposed between respective ones of the voids 56₁-56_{N}. The interconnecting members 37₁-37_{P} may be referred to as “webs” such that the shear band 39 may be viewed as being “web-like” or “webbing”. In this embodiment, the shear band 39 comprises an intermediate band 51 between the outer band 31 and the inner band 33 such that the openings 56₁-56_{N} and the interconnecting members 37₁-37_{P} are arranged into two circumferential rows between adjacent ones of the bands 31, 51, 33.

Each of the inner band 33, the outer band 33 and the intermediate band 51 is an annular portion of the shear band 39 extending continuously in the circumferential direction of the non-pneumatic tire 34. A thickness t_{BAND} of each of the inner band 33, the outer band 33 and the intermediate band 51 in the radial direction of the tire 34 may have any suitable value. In various embodiments, the thickness t_{BAND} of the inner band 33, the thickness t_{BAND} of the outer band 33 and/or the thickness t_{BAND} of the intermediate band 51 may be identical or different.

The voids 56₁-56_{N} of the shear band 39 help the shear band 39 to deflect predominantly by shearing at the contact patch 25 under the loading on the non-pneumatic tire 34. In this embodiment, the voids 56₁-56_{N} are openings that extend from the inboard lateral side 54 to the outboard lateral side 49 of the non-pneumatic tire 34. That is, the openings 56₁-56_{N} extend laterally though the shear band 39 in the axial direction of the non-pneumatic tire 34. The openings 56₁-56_{N} may extend laterally without reaching the inboard lateral side 54 and/or the outboard lateral side 49 of the non-pneumatic tire 34 in other embodiments. In this example, a cross-section of each of the openings 56₁-56_{N} is circular. The cross-section of each of the openings 56₁-56_{N} may be shaped differently in other examples (e.g., polygonal, partly curved and partly straight, etc.). In some cases, different ones of the openings 56₁-56_{N} may have different shapes. In some cases, the cross-section of each of the openings 56₁-56_{N} may vary in the axial direction of the wheel 20ᵢ. For instance, in some embodiments, the openings 56₁-56_{N} may be tapered in the axial direction of the wheel 20ᵢ such that their cross-section decreases inwardly axially (e.g., to help minimize debris accumulation within the openings 56₁-56_{N}).

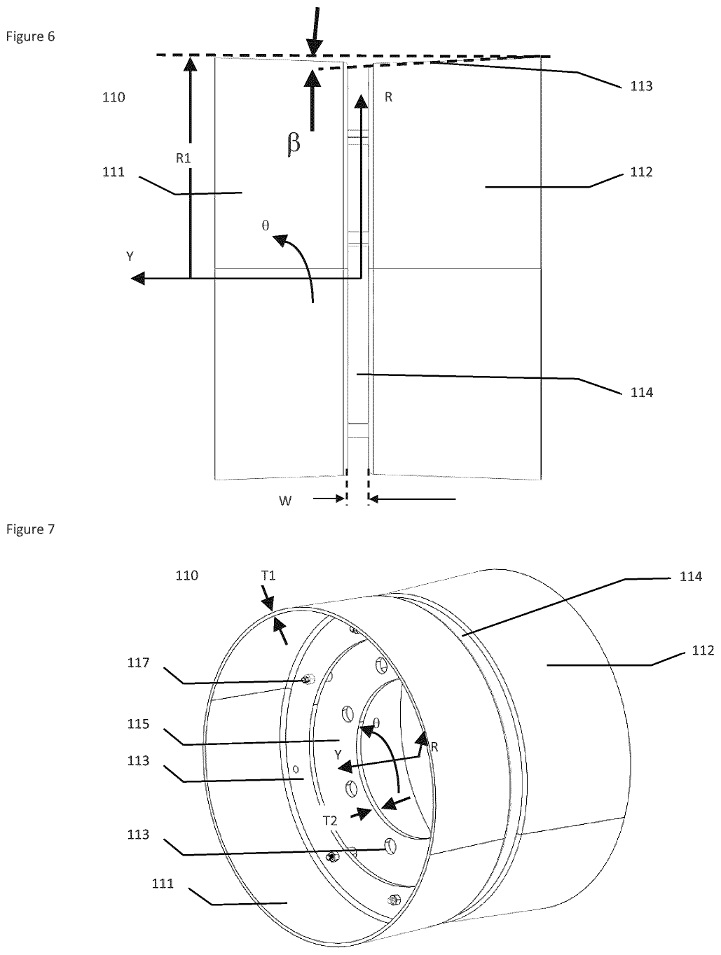

The shear band 39, including the voids 56₁-56_{N} and the interconnecting members 37₁-37_{P}, may be arranged in any other suitable way in other embodiments. For example, in other embodiments, the shear band 39 may comprise a plurality of intermediate bands or no intermediate band like the intermediate band 51 (see e.g. FIGS. 6 and 7), the voids 56₁-56_{N} and/or the interconnecting members 37₁-37_{P} may have any other suitable shapes, etc.

In this embodiment, the non-pneumatic tire 34 comprises a tread 50 for enhancing traction between the non-pneumatic tire 34 and the ground. The tread 50 is disposed about the outer peripheral extent 46 of the annular beam 36, in this case about the outer band 31 of the shear band 39. The tread 50 may be implemented in any suitable way in other embodiments (e.g., may comprise a plurality of tread recesses, tread projections, etc. forming tread blocks).

The annular support 41 is configured to support the loading on the non-pneumatic tire 34 as the non-pneumatic tire 34 engages the ground. As mentioned above, in this embodiment, the annular support 41 is configured to support the loading on the non-pneumatic tire 34 by tension. More particularly, in this embodiment, the annular support 41 comprises a plurality of support members 42₁-42_{T} that are distributed around the non-pneumatic tire 34 and resiliently deformable such that, under the loading on the non-pneumatic tire 34, lower ones of the support members 42₁-42_{T} in the lower portion 27 of the annular support 41 (between the axis of rotation 35 of the non-pneumatic tire 34 and the contact patch 25 of the non-pneumatic tire 34) are compressed and bend while upper ones of the support members 42₁-42_{T} in the upper portion 29 of the annular support 41 (above the axis of rotation 35 of the non-pneumatic tire 34) are tensioned to support the loading. As they support load by tension when in the upper portion 29 of the annular support 41, the support members 42₁-42_{T} may be referred to as “tensile” members.

In this embodiment, the support members 42₁-42_{T} are elongated and extend from the annular beam 36 towards the hub 32 generally in the radial direction of the non-pneumatic tire 34. In that sense, the support members 42₁-42_{T} may be referred to as “spokes” and the annular support 41 may be referred to as a “spoked” support.

More particularly, in this embodiment, the inner peripheral extent 48 of the annular beam 36 is an inner peripheral surface of the annular beam 36 and each spoke 42ᵢ extends from the inner peripheral surface 48 of the annular beam 36 towards the hub 32 generally in the radial direction of the non-pneumatic tire 34 and from a first lateral end 55 to a second lateral end 58 in the axial direction of the non-pneumatic tire 34. In this case, the spoke 42ᵢ extends in the axial direction of the non-pneumatic tire 34 for at least a majority of a width W_{T} of the non-pneumatic tire 34. For instance, in some embodiments, the spoke 42ᵢ may extend in the axial direction of the non-pneumatic tire 34 for more than half, in some cases at least 60%, in some cases at least 80%, and in some cases an entirety of the width W_{T} of the non-pneumatic tire 34. Moreover, the spoke 42ᵢ has a thickness T_{S} measured between opposite surfaces 59, 61 of the spoke 42ᵢ that is significantly less than a length and width of the spoke 42ᵢ.

Also in this embodiment, each spoke 42ᵢ extends freely (i.e., without attaching or otherwise intersecting other material of the tire 34) from the annular beam 36 towards the hub 32 for at least a majority (i.e., a majority or an entirety) of a radial distance Rₛ between the annular beam 36 and the hub 32. More particularly, in this embodiment, each spoke 42ᵢ extends freely from the annular beam 36 to the hub 32, i.e., for the entirety of the radial distance Rₛ between the annular beam 36 and the hub 32.

Thus, in this embodiment, each spoke 42ᵢ may have a free span length that is a significant fraction of the outer diameter D_{T} of the non-pneumatic tire 34. The free span length of the spoke 42ᵢ is the curvilinear distance in the radial direction from one extremity of the spoke 42ᵢ to an opposite extremity of the spoke 42ᵢ, between which there is no attaching or otherwise intersecting material. In some embodiments, the free span length of the spoke 42ᵢ may be at least 15% of the outer diameter D_{T} of the tire 34, in some cases at least 20% of the outer diameter D_{T} of the tire 34, in some cases at least 25% of the outer diameter D_{T} of the tire 34, and in some cases even more. Spoke surface strains decrease with the square of the free span length of the spoke 42ᵢ; thus, it may be advantageous for crack propagation resistance to maximize the free span spoke length.

When the non-pneumatic tire 34 is in contact with the ground and bears a load (e.g., part of a weight of the construction vehicle 10), respective ones of the spokes 42₁-42_{T} that are disposed in the upper portion 29 of the spoked support 41 (i.e., above the axis of rotation 35 of the non-pneumatic tire 34) are placed in tension while respective ones of the spokes 42₁-42_{T} that are disposed in the lower portion 27 of the spoked support 41 (i.e., adjacent the contact patch 25) are placed in compression. The spokes 42₁-42_{T} in the lower portion 27 of the spoked support 41 which are in compression bend in response to the load. Conversely, the spokes 42₁-42_{T} in the upper portion 29 of the spoked support 41 which are placed in tension support the load by tension.

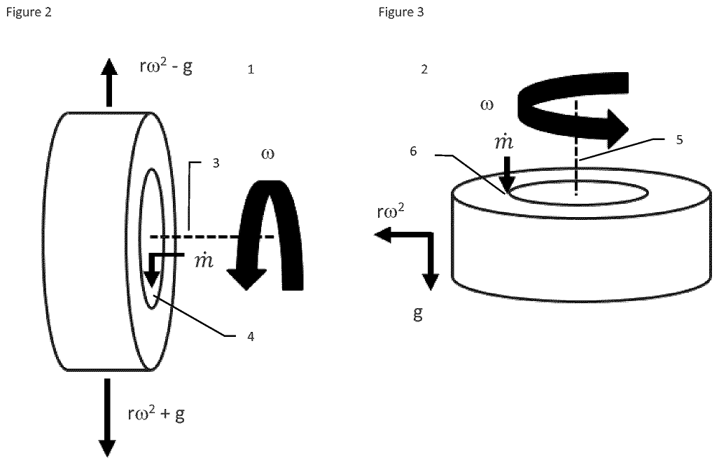

The non-pneumatic tire 34 has an inner diameter D_{TI} and the outer diameter D_{T}. A sectional height H_{T} of the non-pneumatic tire 34 is half of a difference between the outer diameter D_{T} and the inner diameter D_{TI} of the tire 34. The sectional height H_{T} of the tire may be significant in relation to the width W_{T} of the tire 34. In other words, an aspect ratio AR of the tire 34 corresponding to the sectional height H_{T} over the width W_{T} of the tire 34 may be relatively high. For instance, in some embodiments, the aspect ratio AR of the tire 34 may be at least 60%, in some cases at least 80%, in some cases at least 100%, and in some cases even more. Also, the inner diameter D_{TI} of the tire 34 may be significantly less than the outer diameter D_{T} of the tire 34 as this may help for compliance of the non-pneumatic tire 34, as well as increasing the spoke free length. For example, in some embodiments, the inner diameter D_{TI} of the non-pneumatic tire 34 may be no more than half of the outer diameter D_{T} of the non-pneumatic tire 34, in some cases less than half of the outer diameter D_{T} of the non-pneumatic tire 34, in some cases no more than 40% of the outer diameter D_{T} of the non-pneumatic tire 34, and in some cases even a smaller fraction of the outer diameter D_{T} of the non-pneumatic tire 34. In the specific embodiment of FIG. 2A, D_{T}=33″, W_{T}=12″ and D_{TI}=16.5″. This tire size is often used in the construction industry for example for skid-steer loaders and telehandlers.

The hub 32 is disposed centrally of the non-pneumatic tire 34 and connects the wheel 20ᵢ to the axle 17. The hub 32 comprises a rim 110, which may be rigid (e.g., metallic), as further discussed later. The hub 32 may be implemented in any suitable manner.

The wheel 20ᵢ may be made up of one or more materials. The non-pneumatic tire 34 comprises a tire material 45 that makes up at least a substantial part (i.e., a substantial part or an entirety) of the non-pneumatic tire 34. The hub 32 comprises a hub material 72 that makes up at least a substantial part of the hub 32. In some embodiments, the tire material 45 and the hub material 72 may be different materials. In other embodiments, the tire material 45 and the hub material 72 may be a common material (i.e., the same material).

In this embodiment, the tire material 45 constitutes at least part of the annular beam 36 and at least part of the spokes 42₁-42_{T}. Also, in this embodiment, the tire material 45 constitutes at least part of the tread 50. More particularly, in this embodiment, the tire material 45 constitutes at least a majority (e.g., a majority or an entirety) of the annular beam 36, the tread 50, and the spokes 42₁-42_{T}. In this example of implementation, the tire material 45 makes up an entirety of the non-pneumatic tire 34, including the annular beam 36, the spokes 42₁-42_{T}, and the tread 50. The non-pneumatic tire 34 is thus monolithically made of the tire material 45. In this example, therefore, the annular beam 36 is free of (i.e., without) substantially inextensible reinforcement running in the circumferential direction of the wheel 20ᵢ (e.g., a layer of metal, composite (e.g., carbon fibers, other fibers), and/or another material that is substantially inextensible running in the circumferential direction of the non-pneumatic tire 34). In that sense, the annular beam 36 may be said to be “unreinforced”.

The tire material 45 is elastomeric. For example, in this embodiment, the tire material 45 comprises a polyurethane (PU) elastomer.

The non-pneumatic tire 34 may comprise one or more additional materials in addition to the tire material 45 in other embodiments (e.g., different parts of the annular beam 36, different parts of the tread 50, and/or different parts of the spokes 42₁-42_{T} may be made of different materials). For example, in some embodiments, different parts of the annular beam 36, different parts of the tread 50, and/or different parts of the spokes 42₁-42_{T} may be made of different elastomers. As another example, in some embodiments, the annular beam 36 may comprise one or more substantially inextensible reinforcing layers running in the circumferential direction of the wheel 20ᵢ (e.g., one or more layers of metal, composite (e.g., carbon fibers, glass fibers, other fibers), and/or another material that is substantially inextensible running in the circumferential direction of the wheel 20ᵢ).

The tire 34 may be formed in one molding operation. The tire comprises a rigid (e.g., metallic) rim which is configured to enable filling a mold cavity in which the non-pneumatic tire is formed. The molding process may comprise horizontal spin casting. Further, the non-pneumatic tire may comprise a tread configured with a complex tread pattern. The mold may be configured to enable forming of the tread in the one molding operation.

FIGS. 2 and 3 illustrate a tire mold for Horizontal Spin Casting 1 (HSC) and Vertical Spin Casting 2 (VSC), respectively. With HSC, the tire mold rotates about an axis that is horizontal 3. When the mold rotates with angular velocity co, a radial acceleration of rω² is produced. The acceleration due to gravity, g, is also oriented in the radial plane of the mold when the mold is oriented as shown in FIG. 2. These acceleration vectors are colinear. Thus, the acceleration due to gravity adds to the acceleration due to rotation when the mold rotates through the 6 o'clock position and subtracts when the mold rotates through the 12 o'clock position. If the acceleration due to rotation is sufficiently large, compared to the acceleration due to gravity, the radial acceleration will always be positive.

With HSC, the tire mold may be filled by pouring a liquid tire material at a mass rate in, which is the mass rate with respect to time. The mold is filled from an inner radial extent of the mold 4. The tire mold therefore fills from an outer radial extent to the inner radial extent. Thus, for HSC, the mold must be configured to accept in at some location between the lateral extents of a rim, which may be located at an inner radial extent of the tire material, after the mold is filled.

The VSC process of FIG. 3 comprises a mold that spins around a vertical axis 5. Acceleration directions from gravity and angular velocity are now at right angles. The acceleration due to gravity, g, is not oriented in the horizontal plane in which the mold spins. rω², will add to g, with a resultant that is diagonal with respect to the mold rotation. The mold will begin to fill at the bottom of an outer radial extent of a mold cavity and fill in a diagonal fashion until reaching a top portion of an inner radial extent of the mold cavity. Laminate architectures are therefore not realistic for VSC. However, VSC allows for a filling location at the top of the inner radial extent 6 of the mold cavity. A metallic or other rigid rim that traverses the lateral extents of the tire at the inner radial extents of the tire material may be inserted into such a mold configuration.

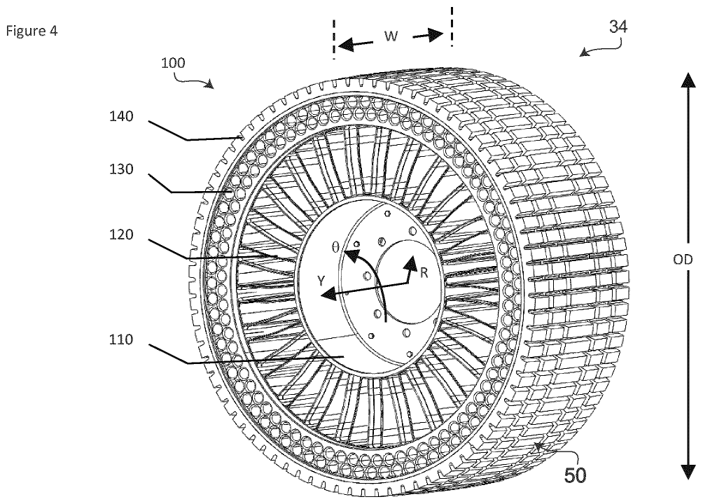

FIG. 4 shows an exemplary embodiment of an NPT 100 according to this disclosure, which is an example of implementation of the non-pneumatic tire 34. This tire may replace a pneumatic tire in the 405/70-20 dimension. This tire may be used by construction vehicles like the example shown in FIG. 1. An outer diameter (OD) of the tire is 1100 mm, and a width (W) is 425 mm. A weight of the tire is 155 kg. The tire can support a load of 3100 kg at a speed of 30 kph in steady-state operation, and a static load of 7000 kg. These performance characteristics are competitive with a radial tire inflated to 3.8 bar.

The tire 100 can be described using radial coordinates. “R” is the radial direction; “θ” is the circumferential direction; and “Y” is the axial, or lateral direction.

The tire 100 comprises a ground-contacting tread portion 140. The tread is adhered or otherwise affixed to an outer radial extent of an annular beam 130. An annular support 120 is adhered or otherwise affixed to the inner radial extent of the annular beam. The annular support structure is adhered or otherwise affixed to a rim 110.

The annular beam may be configured to deflect more by shearing than by bending, when the tire is loaded to a rated load, according to principles disclosed in U.S. Pat. No. 9,751,270. The annular support may be configured to substantially transmit the load from the annular beam to the rim by tension. In FIG. 3, the annular support comprises a plurality of elongated elements that may be referred to as “spokes.” These spokes radially extend from the annular beam to the rim. Further, a plurality of spokes may traverse a significant percentage of the axial width W of the tire. This width may be at least 70% of the width of the annular beam, or, in some cases at least 85%; or, in other cases, even more.

The tire 100 may be manufactured with HSC. It may be formed in one molding operation, including forming the tread. The tread may have features that may not be formed using a simple clamshell mold but may require sectors or other mold features that may necessitate a radial movement of mold entities to enable demolding. The tire may comprise a metallic or other rigid rim that is inserted into the mold, and to which the tire is attached and/or adhered during the molding process.

A material of the rim is stiffer than an elastomeric material of the tire. For example, in some embodiments, a modulus of elasticity of the material of the rim may be at least 20 times, in some cases at least 50 times, in some cases at least 100 times, and in some cases at least 500 times a modulus of elasticity of the elastomeric material of the tire. In this embodiment, the material of the rim is metallic. In other embodiments, rigid plastic and/or composite (e.g., fiber-reinforced plastic) may be used for the rim.

As disclosed in U.S. patent application Ser. No. 15/549,024, HSC enables laminate elastomer architectures. The tire 100 may therefore comprise multiple tire materials. For example, the tread may comprise “Material A”; the annular beam may comprise “Material B′” and the annular support may comprise “Material C.” In other cases, the tread may comprise “Material A” and the annular band and annular support may comprise “Material B.” Any number of possibilities of such architectures are included in the scope of this invention.

The tire materials of tire 100 may be chosen based on criteria disclosed in International Application PCT/CA2018/050534, owned by the current applicant and incorporated by reference herein. Particularly, for HSC, cast polyurethanes may be an excellent material choice. Prior to the molding operation, a cast polyurethane may be a liquid of low viscosity at moderately low temperatures of between 40 C to 90 C. This permits easy pouring into a mold cavity that may comprise a complex geometry. Using sequential pouring, the tread, the annular beam, and the annular support may each comprise a different polyurethane material. Depending on exact polyurethane chemistries and process variables, polymerization may occur in as little as 5 minutes or as long as 1 hour. After a predetermined time, the polyurethane materials obtain strength and resiliency that enables the tire to be demolded.

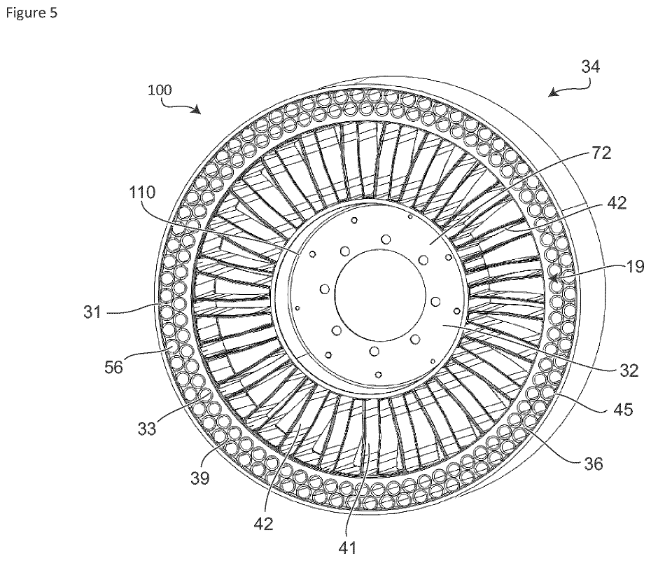

FIG. 5 shows a tire according to this disclosure that does not comprise a tread. This tire may be formed using HSC. This tire may have the tread affixed to the outer radial extent after it has been molded. The tire may comprise a metallic or other rigid rim that is inserted into the mold, and to which the tire is attached and/or adhered during the molding process.

FIGS. 6 and 7 show an exemplary embodiment of the rim 110 that may be used to form a tire according to this disclosure. The rim comprises a left portion 111 and a right portion 112. An outer radial extent of the right portion 113 may be configured to slope downward from an outer axial extent to an inner axial extent, with angle β. The right-side portion may be similarly configured. This angle enables efficient filling of the mold and consistent contact of tire material with the rim 110 during the molding operation. In some cases, angle β may be at least than 1 degree; in some cases, β may be at least 2 degrees, and in some cases even more.

Before the molding operation, the rim is configured to have a space 114 of axial width w between the right side and the left side. This space creates a void. The void extends in a circumferential direction around the entire circumference of the rim. Thus, as the mold rotates, there is a continuous channel into which a liquid tire material may be poured. The void extends in a lateral direction over the width w. The width may be large enough to permit a pouring nozzle having a diameter sufficiently large to accommodate a desired flow rate, or \dot{m}.

The flow rate may be specified to fill the mold within a certain time. The inventor has found that the molding process is improved when mold fill time is no longer than about 15 minutes, and in some cases between 7 to 10 minutes. Thus, for a tire comprising 100 kg of tire material elastomer, the \dot{m} may be at least 7 kg/minute, in some cases between 10 kg/minute to 15 kg/minute. To permit this flow rate, the void width may be between 15 mm to 40 mm.

Smaller tires with less mass may require lower flow rates and therefore a smaller void width. For example, for a tire having an elastomer mass of 15 kg, an \dot{m} of only 4 kg/minute may be sufficient, as this gives a mold fill time of less than 4 minutes. In this case, a void width of 12 mm may be sufficient for processing needs.

FIGS. 6 and 7 show a preferred geometry for configuring the rim. In this case, the inventor has separately formed two rim halves which are then attached with a plurality of spacers, bolts and nuts. The spacers position the two rim halves such that they are radially and circumferentially aligned. Through experimentation, the inventor has found that 3 attachment points are sufficient to provide excellent alignment. In this way, a maximum void is provided for filling the mold.

Both halves have a portion extending in the circumferential and axial directions, with some thickness, T1, at some radius R1 at the lateral extent. This portion may have a draft angle β, such that the rim radius decreases as one moves laterally inward towards the central void created by the two rim halves. This permits the tire material to fully contact the rim as it fills towards the central void area.

Each half has a portion extending in the radial and circumferential directions, with some thickness, T2. In this exemplary example, this portion 115 of the rim right half extends farther down in the radial direction than this portion 113 of the left half. The portion 115 may then be used for fixation to a vehicle hub. Mounting holes for vehicle hub studs may be configured in this portion.

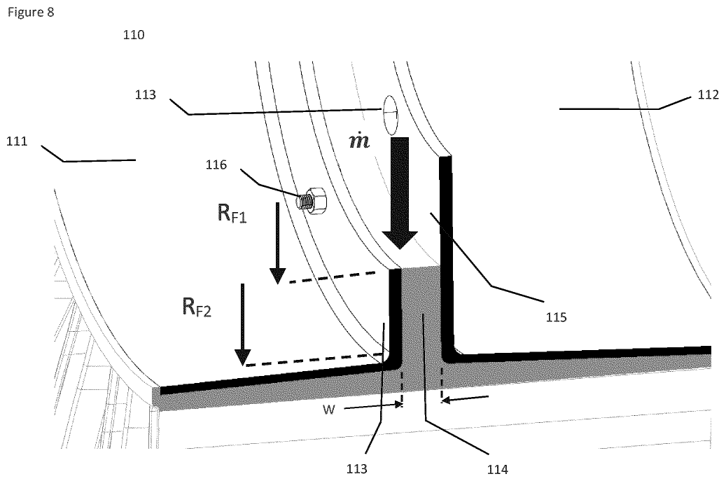

The left half portion 113 does not extend as far in the radial direction. As shown in FIG. 8, this permits easier access for mold filling. The tire depicted in the figure represents the completely molded tire; i.e., the flange area is filled with tire material 114 to approximately the inner radial extent of the left flange. This is useful for structural integrity of the rim area.

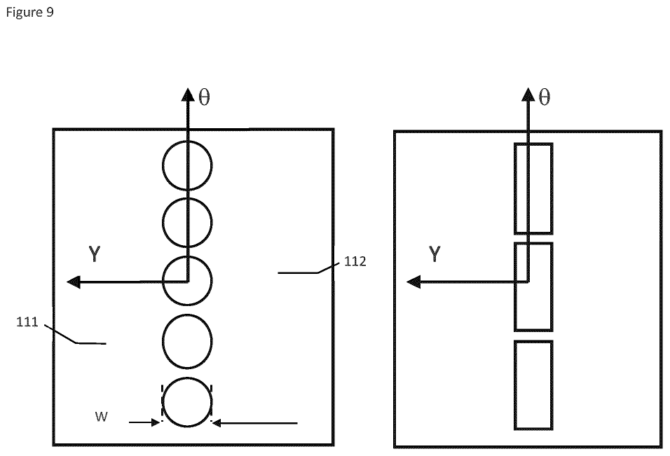

Other alternatives to rim design exist. For example, in FIG. 9 the void area has been created by removing material from a rim that is continuous in the lateral Y direction. Circular, rectangular, or any combination of such cut-out shapes may be used. Any sufficiently large void area may permit pouring a material with the required flow rate \dot{m}.

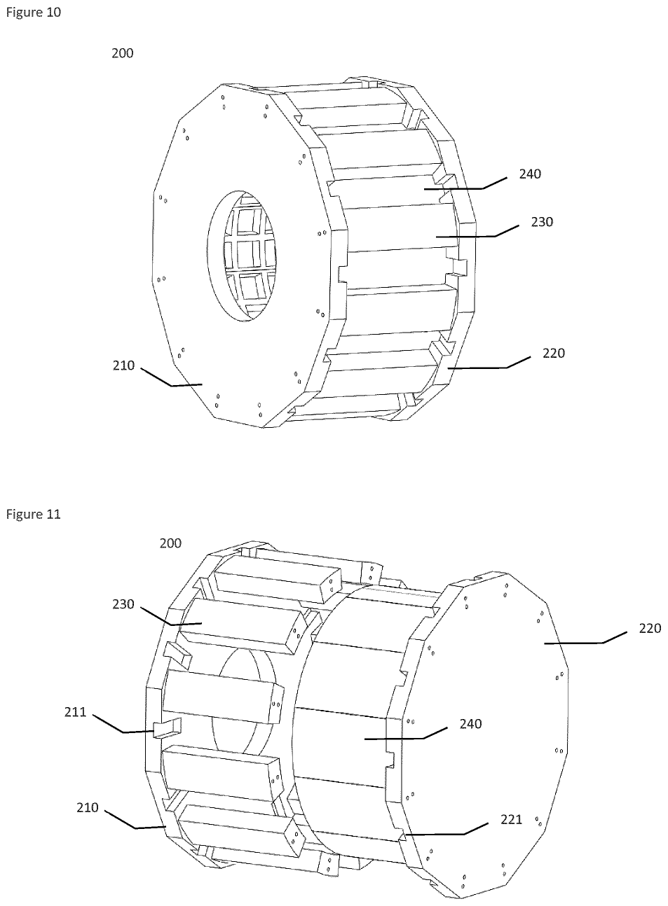

FIG. 10 shows a mold 200 for horizontal spin casting, configured to form a tire according to the current disclosure. The mold comprises a left support disk 210 and a right support disk 220 which extend in the radial direction. Multiple sectors 240 extend in the lateral direction, near the outer radial extent of the disks. These sectors may be configured to attach to and detach from the support disks. Sector support beams 230 also extend in the lateral direction and attach near the outer radial extent of the disks. They are configured to support the sectors at their outer radial extent. Together, the support disks and the support beams position and support the sectors as the mold rotates.

The sectors may comprise a tread pattern on their inner radial extent. The sector tread pattern is the negative of the tire tread pattern. When the mold is closed, a mold cavity is formed, into which a tire tread material may be poured. After the molding process, a tire tread, potentially comprising complex geometries, is formed at the outer radial extent of the tire.

FIG. 11 shows the mold support disks, support beams, and sectors when the mold is opened. The support beams stay attached to the left disk, and disengage from the sectors, which remain affixed to the right disk. In this figure, the sectors are in the “closed” position. This is the position for tire molding.

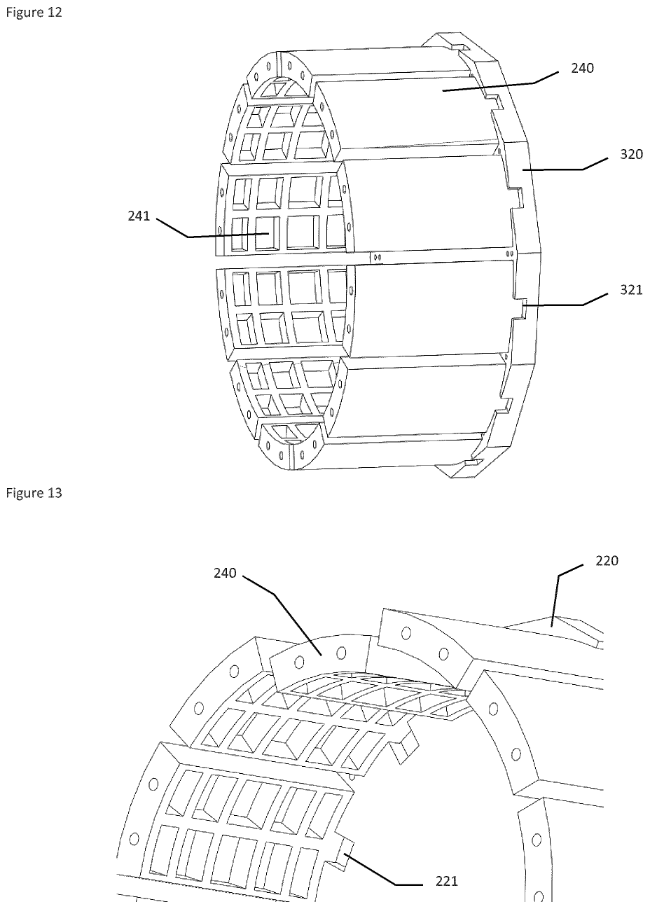

FIG. 12 shows the sectors attached to the right-side support disk when the sectors are in the “open” position. The sector tread pattern 241 is shown on the inner radial extent of the sectors. The sectors are configured to each independently translate in the radial direction, enabling demolding of the tread pattern. Each sector engages the disk in a slot that extends in the radial direction. FIG. 13 shows one sector in the “closed” position and other sectors in the “open” position.

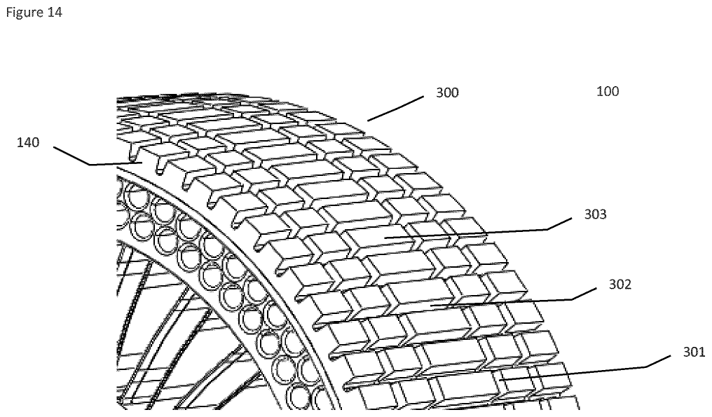

FIG. 14 shows the tire 100, with tread contacting portion 140, with a tread pattern 300. In this embodiment, the tread pattern is molded by the sector tread pattern 241. The tire tread pattern may be complex. For example, in some embodiments, the tread pattern 300 may comprise tread recesses 302 that are respectively disposed between tread projections 303 in the lateral direction of the tire. That is, each tread recess 302 is oriented in the lateral direction of the tire, between adjacent ones of the tread projections 303. In this embodiment, the tread recesses 301 are circumferentially-extending tread recesses which are part of circumferential tread grooves running around the tire. The mold 200 facilities demolding of the tire 100. Also, in this embodiment, the tread 300 comprises both laterally-extending and circumferentially extending recesses. In this embodiment, the tread projections 303 may be considered as tread blocks. The tread pattern 300 may be designed in any other suitable way in other embodiments.

When in the open position, the sector is completely disengaged from the fully formed tire. This is possible when the radial displacement of the sector is at least equal to a tread depth of the tire. When the sectors are in the open position, the tire may be removed from the mold. In this way, a tire having a tread comprising complex features may be formed and then removed from the mold.

While the above described mold kinematic is sufficient for one of ordinary skill in the art to reduce to practice, this disclosure is meant to include other possible mold configurations that accomplish the same function. For example, instead of radial translation, each sector could be configured to rotate around the end at which it contacts the right support disk. This would create clearance for demolding between the sector and the molded tire. Other schemes by which to demold the tire may also be assessable to one of skill in the art. These are meant to be included within the scope of this disclosure.

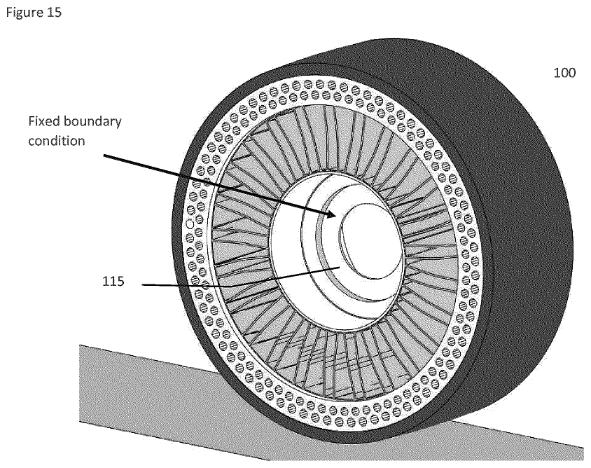

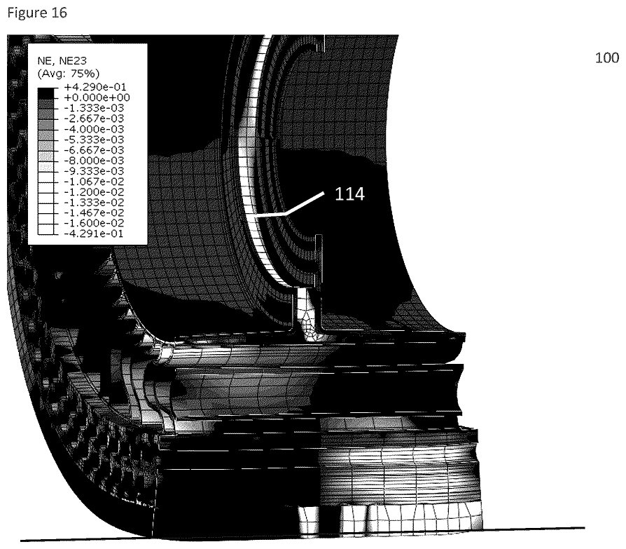

FIGS. 15-16 show FEM models and FEM results of a tire 100 according to the disclosure, in the dimension 405/70-20. The model corresponds to the tire shown in FIG. 3, except that the tread is represented as a smooth pattern. This is done to simplify the FEM. The purpose of this model is to verify proper behavior of the rim. The right-side rim 115 is affixed to the vehicle hub. This is modeled by using a fixed boundary condition on the vertical flange of the right-side rim.

Only the right rim half 115 has the fixed boundary condition; thus, the design of the tire must allow for load transfer from the right side rim to the left side rim. This is accomplished by the tire material 114 between the two rim flanges, as shown previously in FIG. 8.

With reference to FIG. 8, the vertical flange area in the R−θ plane of the left rim vertical flange is:

A_{F}=π(R_{F2}²−R_{F1}²) (1)
Where R_{F2}=flange outer radius
   R_{F1}=flange inner radius

This is approximately equal to the area in the R−θ plane of the tire material that is located between the two rim flanges.

Since the right half of the rim is fixed, the stability of the left-hand side depends on the shear stiffness and strength of the tire material between the two flanges. The inventor has found that the shear strain of this material should be no more than about 0.02, or 2%, to guarantee rim integrity. The shear strain can be approximated by:

$${γ}_{F} = \frac{F}{G {A}_{F}} \qquad ( 2 )$$

Where F=tire load
   G=tire material shear modulus

This allows for a worst-case scenario, in which the two rim halves are only connected by the elastomeric tire material 114. However, connection may also be provided using a mechanical fastener, such as a metallic fixation, such as a bolt 116. In this case, the elastomeric material and the mechanical fastener may work together to provide rim integrity. As such, the overall performance of the tire and rim may be enhanced: if rim/elastomer bonding is reduced for any reason, the bolt connection provides a redundancy in performance. If a bolt connection become loose or fails for any reason, then then the elastomer provides a redundancy in performance.

Taking the 405/70-20 as a practical example for rim integrity, and assuming we have no metallic connections, we have:
G=50 MPA. This is the shear modulus of a preferred tire material.
A_{F}=65,000 mm²
F=70,000 Newtons, which is a maximum static load

From (2), we have: γ_{F}=0.018. This is within the allowable limit of 0.02, or 2% shear strain.

FIG. 16 shows FEM results for the FEA model of the 405/70-20, loaded to 7000 kg. The figure shows that the tire material between the two rim halves does deform in shear. However, the shear strain is less than 0.016 (1.6%).

Therefore, this tire meets the inventor's requirement of keeping the shear strain between the two rim halves below 2%, when loaded to a maximum rated static load of 7000 kg. This strain can be approximated by using relationships provided above.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

Although various embodiments and examples have been presented, this was for purposes of description, but not should not be limiting. Various modifications and enhancements will become apparent to those of ordinary skill in the art.

What is claimed is:

1. A wheel comprising:
a non-pneumatic tire that comprises an elastomeric annular body comprising an elastomeric material; and
a rigid rim extending radially inwardly from the elastomeric annular body and comprising a rigid material stiffer than the elastomeric material;
wherein the elastomeric annular body is molded onto the rigid rim in a mold by rotation of the mold about a horizontal axis of rotation of the mold.

2. The wheel of claim 1, wherein the elastomeric annular body is molded onto the rigid rim without opening the mold during molding of the elastomeric annular body.

3. The wheel of claim 1, wherein the elastomeric annular body is molded onto the rigid rim in a single molding operation.

4. The wheel of claim 1, wherein the elastomeric material is a first elastomeric material and the elastomeric annular body comprises a second elastomeric material different from the first elastomeric material.

5. (canceled)

6. The wheel of claim 4, wherein: the elastomeric annular body comprises a tread; and the tread comprises tread recesses disposed between tread projections in a lateral direction of the non-pneumatic tire.

7. The wheel of claim 6, wherein the tread recesses are circumferentially-extending tread recesses.

8. The wheel of claim 7, wherein the tread comprises laterally-extending recesses that intersect the circumferentially-extending tread recesses.

9. The wheel of claim 1, wherein: the elastomeric annular body comprises a tread; and the tread is demoldable only by movement of at least part of the mold in a radial direction of the non-pneumatic tire.

10. The wheel of claim 9, wherein the movement of at least part of the mold in the radial direction of the non-pneumatic tire is translation of at least part of the mold in the radial direction of the non-pneumatic tire.

11. The wheel of claim 1, wherein the rigid rim is a metallic rim and the rigid material is metallic material.

12. The wheel of claim 1, wherein the rigid rim comprises a void configured to admit the elastomeric material during molding of the elastomeric annular body in the mold.

13. The wheel of claim 12, wherein the rigid rim comprises rim portions spaced from one another in a lateral direction of the non-pneumatic tire to form the void therebetween.

14. The wheel of claim 12, wherein the elastomeric annular body extends into the void of the rigid rim.

15. The wheel of claim 13, wherein the rim portions of the rim are connected to one another only by the elastomeric annular body.

16. The wheel of claim 13, wherein the rim portions of the rim are connected to one another by the elastomeric annular body and a fastener.

17. The wheel of claim 1, wherein the elastomeric annular body comprises: an annular beam configured to deflect at a contact patch of the non-pneumatic tire with a ground surface; and an annular support extending radially inwardly from the annular beam and configured to deform as the non-pneumatic tire rolls on the ground surface.

18. The wheel of claim 17, wherein the annular support is configured such that, when the non-pneumatic tire is loaded, an upper portion of the annular support above an axis of rotation of the non-pneumatic tire is in tension.

19. The wheel of claim 17, wherein the annular support comprises spokes that are configured such that, when the non-pneumatic tire is loaded, upper ones of the spokes above an axis of rotation of the non-pneumatic tire are in tension.

20. (canceled)

21. A non-pneumatic tire comprising an elastomeric annular body, the elastomeric annular body comprising a tread including tread recesses disposed between tread projections in a lateral direction of the non-pneumatic tire, wherein the elastomeric annular body is molded in a mold by rotation of the mold about an horizontal axis of rotation of the mold.

22. (canceled)

23. (canceled)

24. (canceled)

25. (canceled)

26. (canceled)

27. A wheel comprising:
a non-pneumatic tire that comprises an elastomeric annular body comprising an elastomeric material, the elastomeric annular body comprising:
an annular beam configured to deflect at a contact patch of the non-pneumatic tire with a ground surface; and
an annular support extending radially inwardly from the annular beam and configured such that, when the non-pneumatic tire is loaded, an upper portion of the annular support above an axis of rotation of the non-pneumatic tire is in tension;
and
a rigid rim extending radially inwardly from the elastomeric annular body and comprising a rigid material stiffer than the elastomeric material;
wherein: the elastomeric annular body is molded onto the rigid rim in a mold; and the rigid rim comprises a void configured to admit the elastomeric material during molding of the elastomeric annular body onto the rigid rim in the mold;
wherein the elastomeric annular body is molded onto the rigid rim in the mold by rotation of the mold about an axis of rotation of the mold;
wherein the axis of rotation of the mold is horizontal.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)
